(19) United States
(12) Patent Application Publication
(10) Pub. No.: US 2013/0152745 A1
(43) Pub. Date: Jun. 20, 2013

(54) Adjusting System for a Tool

(71) Applicant: Hans-Joachim Pohl, Solingen (DE)

(72) Inventor: Hans-Joachim Pohl, Solingen (DE)

(73) Assignee: RICHARD ABR. HERDER GMBH & CO. KG, Solingen (DE)

(21) Appl. No.: 13/696,369

(22) PCT Filed: Apr. 12, 2011
(86) PCT No.: PCT/EP11/01811

§ 371 Date: Feb. 15, 2013

(30) Foreign Application Priority Data
May 7, 2010 (DE) 102010019878.1

(51) Int. Cl. B25B 23/142

(52) U.S. Cl. CPC B25B 23/1427
USPC 81/467

(57) ABSTRACT

The invention relates to a tool with a housing (3) and a handle (2), a working part (5) which is connected to the housing (3) and serves for opening or closing a screw connection and a coupling which has an adjustment (12) and uncouples the working part (5) from the housing (3) when a working value that can be set by way of the adjustment (12) is reached and/or signals the reaching of the working value that can be set by way of the adjustment. Such a tool in which a correct adjustment of the torque value or tightening torque is retained with a high degree of certainty over a relatively long period of time is created by the adjustment having an adjusting screw with a tensioning system.

The invention relates to a tool, in particular a screwing tool, comprising a handle, a working part which is connected to the housing and serves for opening or closing a screw connection and a coupling which comprises an adjustment and uncouples the working part from the housing when a working value, for example a tightening torque of the screw connection that can be set by means of the adjustment is reached and/or signals the reaching of the working value that can be set by means of the adjustment.

Such tools are known from the state in the art and they are in particular so called torque screwing tools which comprise a handle and a working part, which working part is usually composed of a square which is placed in a head in a rotatable manner and which can be blocked in dependence on the working operation, namely the opening or closing of a screw connection. Furthermore, such tools comprise a device which limits the tightening torque of the tool in dependence on the admissible tightening torque of the screw connection. Thanks to this design, the tool can be set to the admissible tightening torque of the screw connection, such that a too high tightening torque is avoided. Such proceedings are for example known in the assembly of light metal wheels on motor vehicles.

A problem of such tools is that the tightening torques can be adjusted and that the adjustment of such tightening torques does not permanently work correctly, such that such tools have to be calibrated from time to time and, in case of need, to be adjusted.

Furthermore, it is the object of the invention to improve a generic tool in such a way that a correct adjustment of the torque value or the tightening torque will be maintained with high reliability over a longer period of time.

The solution of the above mentioned problem provides that the adjustment comprises an adjusting screw with a tensioning system. The adjustment can be fixed by means of the adjusting screw and the tensioning system in such a way that the adjustment will be maintained over a long period of time such that a regular adjustment in short time intervals won't be required.

The tensioning system preferably consists of a threaded plate which is penetrated by the adjusting screw and of a tensioning screw by means of which the threaded plate can be displaced with respect to the longitudinal axis of the adjusting screw.

According to another feature of the invention it is provided that the adjusting screw and the tensioning screw are placed such that they extend in a slightly diverging alignment from parallel alignment with respect to each other, such that the threaded plate can be tensioned between the adjusting screw and the tensioning screw. By slightly diverging from a parallel alignment, already a divergence of few angular degrees is meant, for example of maximum five angular degrees, such that the tensioning screw extends in parallel and coaxially to the longitudinal axis of the threaded bore of the threaded plate, whereas the adjusting screw extends with respect to the longitudinal axis of the threaded bore with a divergence of a small angle from the alignment of the tensioning screw. Hereby, the tensioning of the threaded plate with respect to the adjusting screw over a short tensioning distance becomes possible. In order to limit the forces of the tensioning of the threaded plate with respect to the adjusting screw in the area of the thread of the adjusting screw or the threaded bore in the threaded plate, the angle is limited to some few angular degrees.

The tool according to the invention is improved in that the tensioning system is placed on a lever which is located in a housing and comprises a releasing system. The releasing system is set with respect to its adjusted torque by means of the tensioning system.

According to another feature of the invention it is furthermore provided that the tensioning system is accessible via an opening in the housing, such that the tensioning system is protected in the housing, on the one hand, and is easily accessible for setting via the opening, on the other hand. The opening can preferably be provided with a cover, such that the cover closes the opening for protecting the tensioning system which is placed behind it. In this case it can also be provided that the cover can only be opened by entering an authorization code, such that the tensioning system is only accessible to a limited group of persons, namely such a group of persons who have got the authorization code.

Finally, it is provided according to another feature of the invention that the tensioning screw can be pre-stressed against the lever.

Other features and advantages of the invention will become apparent from the following description of the associated drawing, in which preferred embodiments of the invention are represented. In the drawing:

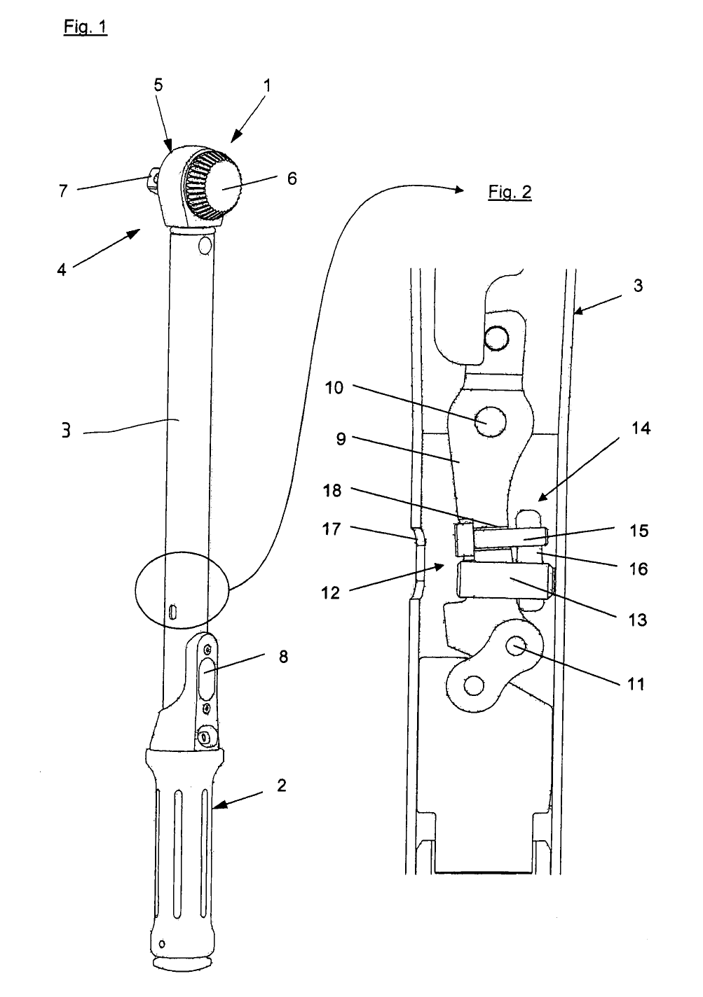

FIG. 1 shows a screwing tool 1 in the form of a torque screwing tool.

FIG. 2 shows a section of a housing of the screwing tool according to FIG. 1 in a cut side view.

FIG. 1 shows a screwing tool 1 in the form of a torque screwing tool having a handle 1 which comprises an essentially circular cross section. The handle 2 is made of synthetic material.

The screwing tool 1 comprises a working part 5 of usual design at an end 4 which is connected to the handle 2. The working part 5 consists of an essentially annular housing 3 into which a rotatable mushroom head 6 is inserted, the turnability of which with respect to the housing 3 can be alternatively determined in both turning directions, and which mushroom head 6 comprises a drive 7 having a square cross section, which drive can be connected to no further represented tool nuts which comprise different sizes of the jaw and which serve for the connection to the no further represented screw connection.

The drive 7 can be set with respect to its transmittable torque by for example rotating the handle 2.

The technique of such a torque screwing tool is sufficiently known and in this connection reference is made to DE 203 15 000 U1 which discloses an embodiment of such a torque screwing tool.

The screwing tool 1 according to FIG. 1 furthermore comprises a display device 8 which serves for displaying various working values. Usually, the tightening torques which are transmitted from the screwing tool 1 to the screw connection are displayed by such display devices 8.

FIG. 2 shows a housing 3 of a screwing tool 1 such as represented in FIG. 1. The housing 3 is shown in a cut side view in FIG. 2 and can have a round cross section.

A lever 9 is lodged in the housing 3 in a pivotable manner around a rotation axis 10 with respect to the housing 3. At its upper end, the lever 9 comprises a bedding 11 for a no further represented releasing system. This releasing system serves for the purpose to generate an audible and sensible signal when a pre-set torque is reached. Herein, partially the flow of forces (torque) to the screw connection will be shortly diminished or interrupted.

This releasing system has to be calibrated from time to time, such that the actually transmitted torques are correctly set. One also speaks of an adjustment of the torque values.

For calibration, the working angle of the releasing system is set by means of the adjusting screw 13. Herein, the lever 9 pivots around the rotation axis 10 during the movement of the adjusting screw 13 and thus influences the working angle of the releasing system.

For the calibration or adjustment of the torque values, the screwing tool 1 according to FIG. 2 comprises an adjustment 12 in the area of the lever 9. The adjustment 12 consists of an adjusting screw 13 and a tensioning system 14 which itself is composed of a tensioning screw 15 and a threaded plate 16.

The tensioning screw 15 and the adjusting screw 13 extend in parallel or anti-parallel by a small angle with respect to each other and are placed in the area of the lever 9 and accessible through an opening 17 in the housing 3.

The threaded plate 16 comprises two threaded bores, wherein the one threaded bore of the threaded plate 16 is penetrated by the adjusting screw 13 and the second bore of the threaded plate 16 is penetrated by the tensioning screw 15. The threaded plate 16 serves to secure the adjusting screw 13, in that the threaded plate 16 is pivoted via the tensioning screw 15 with respect to the longitudinal axis of the adjusting screw 13 and hereby a relative movement of the adjusting screw 13 with respect to the threaded plate 16 and thus to the lever 9 is blocked. For this purpose, the tensioning screw 15 penetrates the lever 9 in the area of a bore 18.

The functioning of the above mentioned tensioning system 14 is the following.

After having set the lever 9 correctly for the adjustment of the torque value by means of the adjusting screw 13, the tensioning screw 15 is turned in such a way that the threaded plate 16 is pivoted with its end that is penetrated by the tensioning screw 15 in the direction of the lever 9. Hereby, the threaded plate 16 is tensioned in the area of its threaded bore penetrated by the adjusting screw 13 with respect to the adjusting screw 13 and fixes this adjusting screw 13 in such a way that settling movements of the adjusting screw 13 with respect to the lever 9 are nearly excluded. The design of the tensioning system 14 enables nearly any number of repetitions of the adjustment of the screwing tool 1 without the securing of the correct torque value provided by the tensioning system 14 losing its efficiency.

Furthermore, it can be provided that the opening 17 is closed by a cover, the removal of which is only possible after entering an authorization code.

Other modifications of this tensioning system 14 are of course possible. For example, the tensioning screw 15 can be fixed in its position with respect to the lever 9 in the bore 18, such that also a pivoting of the threaded plate 16 with its end penetrated by the adjusting screw 13 away from the lever 9 is possible. Furthermore, it can be provided that the opening 17 is closed by a cover, the removal of which is only possible after entering an authorization code.

### LIST OF REFERENCE NUMERALS

1 screwing tool

2 handle

3 housing

4 end

5 working part

6 mushroom head

7 drive

8 display device

9 lever

10 rotation axis

11 bedding

12 adjustment

13 adjusting screw

14 tensioning system

15 tensioning screw

16 threaded plate

17 opening

18 bore

1. A tool, in particular a screwing tool, comprising a housing (3) and a handle (2), a working part (5) which is connected to the housing (3) and serves for opening or closing a screw connection and a coupling which comprises an adjustment (12) and uncouples the working part (5) from the housing (3) when a working value, for example a tightening torque of the screw connection that can be set by means of the adjustment (12) is reached and/or signals the reaching of the working value that can be set by means of the adjustment,
characterized in
that the adjustment (12) comprises an adjusting screw (13) with a tensioning system (14).

2. A tool according to claim 1,
characterized in
that the tensioning system (14) consists of a threaded plate (16) which is penetrated by the adjusting screw (13) and of a tensioning screw (15) by means of which the threaded plate (16) can be displaced with respect to the longitudinal axis of the adjusting screw (13).

3. A tool according to claim 1,
characterized in
that the adjusting screw (13) and the tensioning screw (15) are placed such that they extend in a slightly diverging alignment from parallel alignment with respect to each other or in parallel to each other.

4. A tool according to claim 1,
characterized in
that the tensioning system (14) is located in a housing (3) and placed on a lever (9) which comprises a releasing system.

5. A tool according to claim 4,
characterized in
that the tensioning system (14) is accessible through an opening (17) in the housing (3).

6. A tool according to claim 4,
characterized in
that the tensioning screw (15) can be pre-stressed against the lever (9)
